(19) United States
(12) Patent Application Publication
(10) Pub. No.: US 2026/0014993 A1
(43) Pub. Date: Jan. 15, 2026

(54) APPARATUS FOR ESTIMATING WEIGHT INFORMATION OF WASTE, WASTE COLLECTION VEHICLE, AND METHOD FOR ESTIMATING WEIGHT INFORMATION OF WASTE

(71) Applicant: Isuzu Motors Limited, Yokohama-shi (JP)

(72) Inventor: Keita ARATO, Fujisawa-shi (JP)

(73) Assignee: Isuzu Motors Limited, Yokohama-shi (JP)

(21) Appl. No.: 19/238,243

(22) Filed: Jun. 13, 2025

(30) Foreign Application Priority Data
Jul. 12, 2024 (JP) 2024-112546

(51) Int. Cl. B60W 40/13

(52) U.S. Cl. CPC B60W 40/13; B60W 2300/12; B60W 2540/215; B60W 2556/15

(57) ABSTRACT

An apparatus for estimating weight information of waste, includes a processor configured to: specify one of a plurality of modes as an operation mode of a waste collection vehicle, the plurality of modes including: a first mode in which waste is collected at a plurality of spots by activating a mounting on the waste collection vehicle for a shorter period of time than a predetermined period of time at each of the spots; and a second mode in which waste is collected by continuously activating the mounting for the predetermined period of time or longer; acquire an activation time during which the mounting on the waste collection vehicle has been activated in the specified operation mode; and acquire information on a weight of the waste based on the activation time and the operation mode.

### CROSS REFERENCE TO RELATED APPLICATIONS

This application is based upon and claims the benefit of priority from prior Japanese Patent Application No. 2024-112546, filed Jul. 12, 2024, the entire contents of which are incorporated herein by reference.

### FIELD

The present invention relates to an apparatus for estimating weight information of waste collected by a waste collection vehicle, a waste collection vehicle, and a method for estimating weight information of waste.

### BACKGROUND

In the case of measuring a weight of waste collected by a waste collection vehicle, it is possible to collect data in real time by providing operation service using a waste collection vehicle equipped with, for example, a metering device. Jpn. Pat. Appln. KOKAI Publication No. 2021-56110 discloses, for example, a technique of estimating a weight of waste. There is also a technique of measuring a weight of waste by measuring a total weight of a waste collection vehicle loaded with waste at, for example, a waste incineration plant after the waste collection vehicle has collected the waste and calculating a difference from a weight of the waste collection vehicle in a no-waste state.

### SUMMARY

According to one aspect of the present invention, an apparatus for estimating weight information of waste, includes a processor configured to: specify one of a plurality of modes as an operation mode of a waste collection vehicle, the plurality of modes including: a first mode in which waste is collected at a plurality of spots by activating a mounting on the waste collection vehicle for a shorter period of time than a predetermined period of time at each of the spots; and a second mode in which waste is collected by continuously activating the mounting for the predetermined period of time or longer; acquire an activation time during which the mounting on the waste collection vehicle has been activated in the specified operation mode; and acquire information on a weight of the waste based on the activation time and the operation mode.

### BRIEF DESCRIPTION OF THE DRAWINGS

FIG. 1 is a schematic diagram showing a system for estimating weight information of waste according to a first embodiment.

FIG. 2 is a schematic diagram showing a waste collection vehicle (garbage truck/dustcart).

FIG. 3 is a diagram showing a processing flow of the system shown in FIG. 1.

FIG. 4 is a schematic diagram showing a waste collection vehicle including an apparatus for estimating weight information of waste according to a second embodiment.

### DETAILED DESCRIPTION

Embodiments of the present invention will be explained referring to the drawings.

In the embodiments, it is assumed that the terms “waste”, “trash”, “garbage”, “rubbish”, “litter”, “refuse”, etc., used to refer to what is generally known as waste. That is, in the embodiments, “waste” intends to include “trash”, “garbage”, “rubbish”, “litter”, “refuse”, and the like.

### First Embodiment

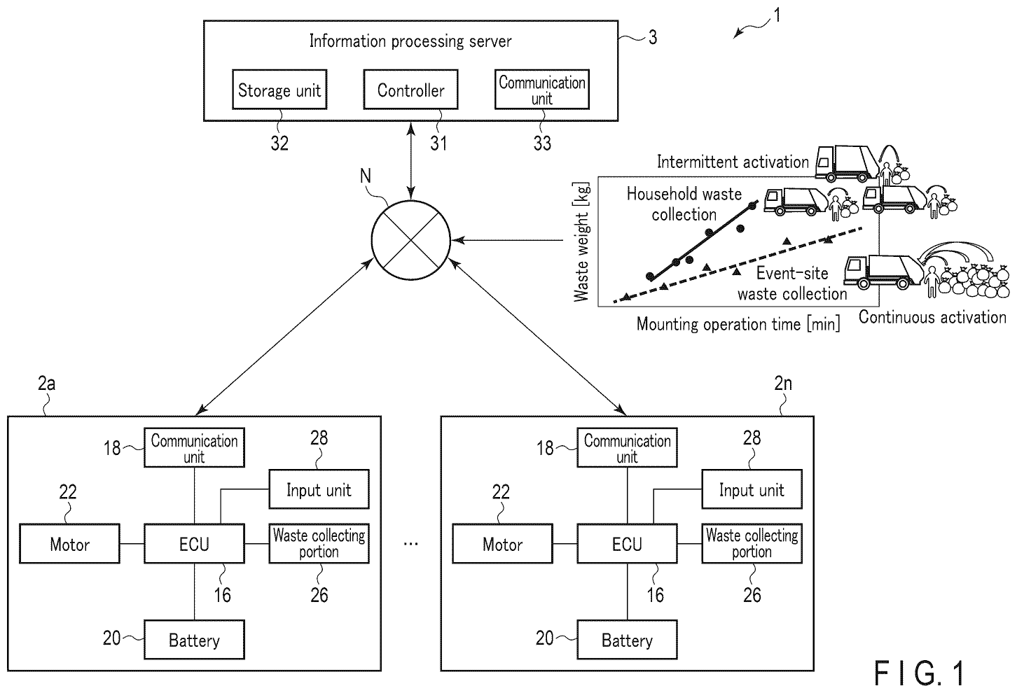

A system for estimating weight information of waste (hereinafter mainly referred to as a “system”) 1 according to a first embodiment will be described with reference to FIGS. 1 to 3.

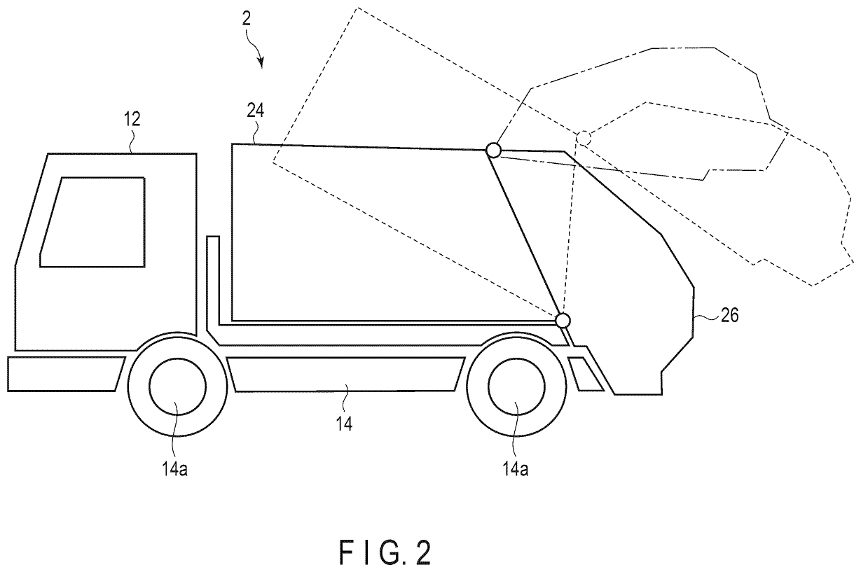

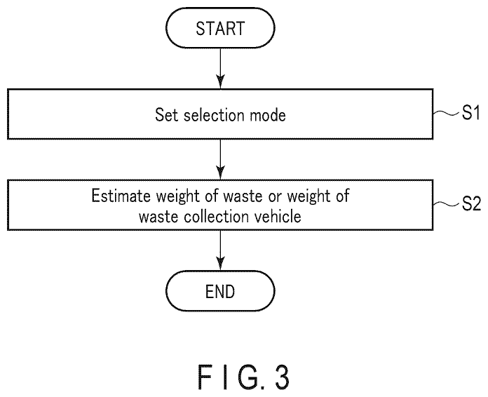

FIG. 1 is a schematic diagram of the system 1 according to the first embodiment of the present invention. The graph of FIG. 1 shows a relationship between an operation time of a waste collecting portion 26 provided as a mounting and a weight of waste (first and second information), which is acquired by a server 3 and temporarily stored therein, and then stored in, for example, a storage unit 32 of the server 3. FIG. 2 is a schematic diagram showing a waste collection vehicle (garbage truck/dustcart) 2. FIG. 3 shows a processing flow of the system 1.

As shown in FIG. 1, the system 1 includes n waste collection vehicles 2a to 2n (where n is an integer equal to or greater than 1) and an information processing server (apparatus for estimating weight information of waste) 3 that is communicable with the waste collection vehicles 2a to 2n via a network N.

In the description that follows, the n waste collection vehicles 2a to 2n will be simply referred to as “waste collection vehicles 2” with the individual symbols omitted if they do not need to be distinguished from one another. As a matter of course, it is preferable for the waste collection vehicles 2a to 2n be the same type of waste collection vehicles with the same mounting; however, they may be different types of waste collection vehicles with the same mounting. Furthermore, the waste collection vehicles 2a to 2n may be waste collection vehicles of different types with different mountings to which the relationship of the graph shown in FIG. 1 can be applied. If the relationship of the graph shown in FIG. 1 cannot be applied to the mounting of the waste collection vehicle 2, a graph of a relationship similar to the relationship of the graph shown in FIG. 1 that can be applied to the mounting on the waste collection vehicle 2 should be prepared.

As shown in FIGS. 1 and 2, the waste collection vehicle 2 includes, in addition to the cab 12 and the chassis 14, an electronic control unit (ECU) 16, a communication unit 18, a battery 20, a motor 22, a waste storing portion 24, a waste collecting portion 26, and an input unit 28.

Permissible examples of the waste collection vehicle 2 according to the present embodiment include an electric vehicle (EV) and an engine vehicle such as a diesel engine vehicle, a hybrid electric vehicle (HEV), a plug-in hybrid electric vehicle (PHEV), or a fuel cell electric vehicle (FCEV). It is assumed herein that the waste collection vehicle 2 is an EV, and an ECU 16, a communication unit 18, a battery 20, a motor 22, a waste storing portion 24, and a waste collecting portion 26 are disposed in the chassis 14. Of these elements, the waste storing portion 24 and the waste collecting portion 26 are disposed as a mounting on the truck.

The ECU 16 is a computer of the waste collection vehicle 2 configured to control each unit of the waste collection vehicle 2. The ECU 16 controls the entire operation of the waste collection vehicle 2 in accordance with programs stored in a storage unit of the ECU 16. The ECU 16 is configured of, for example, electronic circuitry such as one or more processors, such as CPUs. The ECU (processor) 16 executes various programs stored in the storage unit of the ECU 16 to realize corresponding functions and execute various operations.

The waste collection vehicle 2 may include either a single ECU 16 or a plurality of ECUs 16, for example, an ECU for controlling elements related to the vehicle moving and an ECU for controlling the mounting such as the waste collecting portion 26. For ease of explanation, a case is assumed herein, as an example, where a single ECU 16 is provided in the waste collection vehicle 2. Even in the case where the plurality of ECUs 16 are divided into the one for controlling the elements related to the vehicle moving and the one for controlling the mounting such as the waste collecting portion 26, the waste collection vehicle 2 is controlled similarly to the case of a single ECU 16.

The communication unit 18 transmits and receives various information signals related to the waste collection vehicle 2 to and from a server (computer) 3 of the system 1 via the network N.

The battery 20 supplies, to the ECU 16, the communication unit 18, the motor 22, the waste collecting portion 26, etc., a suitable amount of power to be controlled by the ECU 16.

The motor 22 is used as a drive source for driving the wheels 14a of the waste collection vehicle 2 by power from the battery 20.

The waste storing portion 24 is, for example, provided between the cab 12 and the waste collecting portion 26, and is formed as a container for storing waste.

The waste collecting portion 26 operates a hydraulic device of the waste collecting portion 26 by power from the battery 20, and causes the waste storing portion 24 to store waste. Also, the waste collecting portion 26 operates the hydraulic device of the waste collecting portion 26 by power from the battery 20, and causes the waste to be discharged to the outside of the waste collection vehicle 2 from the waste storing portion 24. Thus, the waste collecting portion 26 can switch between a mode of storing waste in the waste storing portion 24 and a mode of discharging waste put into the waste storing portion 24 to the outside. In the present embodiment, for ease of explanation, it is assumed that, in either mode of operation, the hydraulic device of the waste collecting portion 26 is operated by a pressing-down of a switch of the waste collecting portion 26.

As a mechanism by which the waste collecting portion 26 stores waste in the waste storing portion 24, any one of the known methods such as a rotating type (rotating-plate type), a pressing type (pressure-plate type), a rotary type that uses a drum, or the like may be used. In the present embodiment, it is assumed that a rotary-type mechanism is used for the waste collecting portion 26 in the collection mode.

At a waste incineration plant, etc., the waste storing portion 24 and the waste collecting portion 26 may be disposed at, for example, the positions shown by the dashed lines, or the waste collecting portion 26 may be disposed at, for example, the position shown by the two-dot chain line, such that the waste stored in the waste storing portion 24 can be easily discharged.

In the present embodiment, it is assumed that a mounting (e.g., a hydraulic device of the waste collecting portion 26) on the waste collection vehicle 2 is driven to sequentially discharge the waste stored in the waste storing portion 24 to the outside of the waste collection vehicle 2. As a mechanism by which the waste is discharged from the waste storing portion 24, any one of the known methods such as the rotary type that inversely rotates a drum, a pushing type that moves a pusher plate (not illustrated), or a dump type that lifts the waste storing portion 24 using, for example, a hoist mechanism (not illustrated) may be used.

In the case of using, for example, the dump type, the waste storing portion 24 is tilted using the hoist mechanism, and the waste collecting portion 26 is rotated relative to the waste storing portion 24 to open the waste storing portion 24 and discharge waste therefrom. In the case of using, for example, the dump type, the waste storing portion 24 and the waste collecting portion 26 of the waste collection vehicle 2 move between the position indicated by the solid line and the position indicated by the dashed line in FIG. 2. In the case of using the pushing type, the waste collecting portion 26 is rotated relative to the waste storing portion 24 to open the waste storing portion 24 and discharge waste with the pusher plate, as shown by the two-dot chain line in FIG. 2.

In the present embodiment, the input unit 28 is used for an input to select a mode from among operation modes (selection modes), to be discussed below. The input unit 28 should be provided in, for example, the cab 12, the waste storing portion 24, or the waste collecting portion 26. Also, an information terminal such as a smartphone carried by a worker may be used as, for example, an input unit 28 that is connected via the communication unit 18.

In the present embodiment, it is assumed that the operation modes include a first mode in which the waste collecting portion 26 is intermittently activated to collect, for example, household waste, and a second mode in which the waste collecting portion 26 is basically continuously activated to, for example, collect waste at an event site, etc.

It is assumed that, in the first mode, waste is collected at a plurality of locations or spots by intermittently activating the mounting (the hydraulic device of the waste collecting portion 26) on the waste collection vehicle 2 in a series of waste collection procedures, with the hydraulic device of the waste collecting portion 26 being activated for a shorter period of time than a predetermined period of time at each of the spot.

It is assumed that, in the second mode, waste is collected by continuously activating the mounting (the hydraulic device of the waste collecting portion 26) on the waste collection vehicle 2 for the predetermined period of time or longer. In the second mode, if the mounting is intermittently activated, the amount of movement of the waste collection vehicle 2 is set to a predetermined value or below.

The worker of the waste collection vehicle 2 drives the waste collection vehicle 2 to move it to a predetermined number of (e.g., one or more than one) locations or spots of waste collection, and drives the hydraulic device of the waste collecting portion 26 to cause the waste storing portion 24 to store waste at each spot where the waste collection vehicle 2 is stopped. Also, the worker drives the waste collection vehicle 2 to move it to, for example, a predetermined waste incineration plant, etc., and drives the hydraulic device of the waste collecting portion 26 to discharge the waste put into the waste storing portion 24 to the outside at the waste incineration plant, etc., where the waste collection vehicle 2 is stopped. In this manner, the waste collection vehicle 2 consumes power from the battery 20, for example, at the time of moving to one or more spots for waste collection, at the time of moving to a waste incineration plant, etc. for waste discharging after the waste collection, and at the time of operation (collection and discharging) of the waste collecting portion 26.

Here, a running resistance Rₜₒₜₐₗ (N) at the time of moving of the waste collection vehicle 2 can be expressed by the following Formula (1):

$${R}_{total} = {R}_{r} + {R}_{a} + {R}_{g} + {R}_{i} \qquad ( 1 )$$

Here, Rr(N) denotes a rolling resistance, Ra(N) denotes an air resistance, Rg(N) denotes a gradient resistance, and Ri(N) denotes an acceleration resistance. Due to the running resistance Rₜₒₜₐₗ, the waste collection vehicle 2 consumes power from the battery 20 at the time of moving (traveling).

The rolling resistance Rr mainly refers to a resistance generated by energy loss due to deformation of tires of the waste collection vehicle 2. The rolling resistance Rr can be expressed by the following Formula (2):

$${R}_{r} = {μ}_{r} {m}_{test} \qquad ( 2 )$$

It is assumed herein that μᵣ is a rolling resistance coefficient, which herein includes a gravitational acceleration g(m/s²). The rolling resistance coefficient μᵣ is affected by, for example, the situation of the road (the material with which the road is paved, whether the road is dry or wet, etc.), the tires (type, air pressure, etc.), the wheel weight, the state of the axle (temperature of the grease), etc. Here, mₜₑₛₜ denotes a total weight (kg) of the waste collection vehicle 2 including the mounting and the waste. It is preferable that the total weight include a weight, etc. of the worker who sits in and moves the waste collection vehicle 2. The rolling resistance Rr increases in proportion to the total weight of the waste collection vehicle 2. The rolling resistance Rr is affected not only by the weight of the waste collection vehicle 2 itself, but also by the weight of the waste.

The air resistance Ra denotes a resistance generated by a friction between the air and the surface of the waste collection vehicle 2 including the mounting. The air resistance Ra can be expressed by the following Formula (3):

$${R}_{a} = {μ}_{a} {v}_{x}^{2} \qquad ( 3 )$$

Here, μₐ denotes a coefficient obtained by multiplying an air resistance coefficient (N⋅m⁻²⋅(km/h)⁻²) by a frontal projected area (m²) of the waste collection vehicle 2. Accordingly, μₐ changes according to the frontal shape (the cab 12, the chassis 14, the waste storing portion 24, etc.) of the waste collection vehicle 2. Also, Vₓ denotes a moving speed (km/h) of the waste collection vehicle 2. The air resistance Ra increases in proportion to a square of the vehicle speed. It can thus be seen that, the faster the speed of the waste collection vehicle 2, the greater the power consumption during moving.

The gradient resistance Rg denotes, for example, a resistance generated at the time of climbing, for example. The gradient resistance Rg can be expressed by the following Formula (4):

$${R}_{g} = {m}_{test} g sin β \qquad ( 4 )$$

Here, mₜₑₛₜ denotes a total weight (kg) of the waste collection vehicle 2 including the mounting and the waste of the waste collection vehicle 2, where g denotes a gravitational acceleration (m/s²), and β of a sin β (not illustrated) denotes an inclination angle of a road surface relative to a horizontal surface. The gradient resistance Rg is proportional to the total weight of the waste collection vehicle 2 and the sin β of the inclination angle β. The gradient resistance Rg is thus affected not only by the weight of the waste collection vehicle 2 itself, but also by the weight of the waste. The gradient resistance Rg changes according to a change in gradient of the position at which the waste collection vehicle 2 travels. It can thus be seen that, the greater the weight of the waste and the greater the gradient while the waste collection vehicle 2 is moving, the greater the power consumption during moving.

The acceleration resistance Ri denotes a resistance generated at the time of acceleration. The acceleration resistance Ri can be expressed by the following Formula (5):

$${R}_{i} = ( {m}_{test} + Δ {m}_{drv + eng} ) {\dot{v}}_{x} \qquad ( 5 )$$

Here, mₜₑₛₜ is a total weight (kg) of the waste collection vehicle 2 including the mounting and the waste, and Δm_{drv+eng} is an inertia equivalent mass (kg) of rotating portions of a drive mechanism. The inertia equivalent mass can be obtained by converting, into weights, inertia forces of the rotating portions of the drive mechanism, namely, an engine, a transmission, a propeller shaft, a differential, and rear wheels, which need to be accelerated at the time of acceleration of the vehicle. Here, vₓ denotes a vehicle moving speed (km/h), and denotes an acceleration in Formula (5). The acceleration resistance Ri is proportional to the acceleration and the weight of the waste collection vehicle 2. The acceleration resistance Ri is affected not only by the weight of the waste collection vehicle 2 itself, but also by the weight of the waste, etc.

The running resistance Rₜₒₜₐₗ while the waste collection vehicle 2 is moving is thus affected not only by the weight of the waste collection vehicle 2 and the weight of the worker, but also by the weight of the waste. As a matter of course, the larger the running resistance Rₜₒₜₐₗ, the greater the power consumption (energy) during moving (during traveling) of the waste collection vehicle 2, resulting in lower power efficiency.

FIG. 1 is a block diagram schematically showing a configuration example of the information processing server 3 according to the present embodiment.

The server 3 is a computer including a control unit 31, a storage unit 32, and a communication unit 33. The control unit 31, the storage unit 32, and the communication unit 33 are mutually connected via a bus line.

The control unit 31 controls the entire operation of the information processing server 3 in accordance with programs stored in the storage unit 32. The control unit 31 is configured of, for example, electronic circuitry such as one or more processors. It is assumed, for example, that the control unit 31 is a CPU. The control unit 31 executes various programs stored in the storage unit 32 to realize corresponding functions and execute various operations.

The storage unit 32 is configured of a main storage and an auxiliary storage. The main storage is configured of, for example, a volatile memory that provides a work area for a processor. The main storage is configured of, for example, a random-access memory (RAM), etc. The auxiliary storage is, for example, a non-transitory storage medium, and is configured of, for example, a nonvolatile memory configured to store a variety of information and programs for operation of the information processing server 3. The auxiliary storage is configured of, for example, a hard disk drive (HDD) or a solid-state drive (SSD). The storage unit 32 causes the control unit 31 to store programs for realizing various functions. Note that, in the present embodiment, the storage unit 32 is configured, for example, to store a waste weight estimating program, which is executed by the control unit 31. The storage unit 32 further stores information (first and second information) shown in the graph of FIG. 1, which is provided via, for example, the network N. That is, the storage unit (storage medium) 32 stores first information related to a change in weight of the waste relative to an activation time of the mounting in the first mode and second information related to a change in weight of the waste relative to an activation time of the mounting in the second mode. It is preferable that, after a series of waste collection procedures have ended, the server 3 measure a weight of the waste collection vehicle 2 at, for example, a waste incineration plant, etc., acquire a relationship between an accumulated operation time of the mounting and weight information of the waste from at least some of the waste collection vehicles 2a to 2n, and update information of the graph shown in FIG. 1 stored in the storage unit 32.

FIG. 1 shows a graph in which the lateral axis represents an operation time of the waste collecting portion 26 as a mounting, and the vertical axis represents a weight of the waste. The data shown in FIG. 1 is an example of data (first information) obtained by actually collecting household waste at a plurality of spots on a route, and data (second information) obtained by collecting waste after completion of an event at a site or a location. It is preferable that such data (first and second information) be provided for the respective waste types into which waste is sorted, although sorting of household waste differs according to the local government.

The operation time of the waste collecting portion 26 is a period of time during which the hydraulic device of the waste collecting portion 26 has been operated using power from the battery 20 in response to a pressing-down of the switch of the waste collecting portion 26 by a waste collecting worker. In the case of collecting household waste, for example, the hydraulic device of the waste collecting portion 26 is continuously activated at each collection spot; however, the hydraulic device of the waste collecting portion 26 is not usually maintained in an activated state while the vehicle moves to the next point, and is intermittently activated in most cases, namely, activated at each collection spot and then stopped and moved to the next spot. On the other hand, in the case of collecting waste at an event site, for example, the hydraulic device of the waste collecting portion 26 is continuously activated in most cases.

It can be seen, from the graph shown in FIG. 1, that, in the case of household waste collection (first mode), there is a tendency for the weight to increase in a short period of operation time of the hydraulic device of the waste collecting portion 26, compared to the case of the event-site waste collection (second mode). However, such a tendency is shown merely as an example, and may change according to the type, etc. of waste. The household waste can be sorted into, for example, plastics, PET bottles, metals, paper, and others, although such sorting differs according to the local government. Thus, the weight of the waste collected by the waste collection vehicle 2 may change according to the type of waste and the day of the week of collection. On the other hand, the event-site waste can be sorted into, for example, PET bottles, paper containers for eating and drinking, plastic containers for eating and drinking, and others. Also, the weight of the waste collected by the waste collection vehicle 2 changes according to the products, etc. being sold at the event site.

The communication unit 33 is configured of one or more communication interfaces capable of performing communications compliant with a given wireless communication standard. The communication unit 33 includes one or more communication interfaces that enable communications between the information processing server 3 and the waste collection vehicle 2 via the network N, as described above.

A hardware configuration of the information processing server 3 is not limited to the above-described one. The above-described constituent elements of the information processing server 3 can be suitably omitted and/or altered; furthermore, new constituent elements may be suitably added.

The system 1 is what is known as a client-server system. The system 1 is realized through mutual communication between the server 3 and the ECU 16 of each of n waste collection vehicles 2, which are clients, via the network N and the communication units 18 and 33. Note that the network N is realized by a network such as the Internet, a mobile telephone network, or a local area network (LAN), or a network that is a combination of them.

A waste weight estimating process as realized by the control unit 31 of the information processing server 3 will be described with reference to FIG. 3. Each of the processes being realized by the control unit 31 may be rephrased as being realized by a computer including a processor.

First, it is assumed, for example, that a worker of the waste collection vehicle 2 has selected the first mode in a state in which the waste storing portion 24 of the waste collection vehicle 2 is empty, and inputs the selected operation mode to the input unit 28 of the waste collection vehicle 2 (step S1). In accordance with the input to the input unit 28, the ECU 16 transmits the operation mode (first mode) to the information processing server 3 via the communication unit 18. The server 3 specifies the waste collection vehicle 2.

The worker drives the waste collection vehicle 2, stops it at a predetermined waste collection spot, presses down the switch of the waste collecting portion 26, and operates the hydraulic device of the waste collecting portion 26.

The ECU 16 of the waste collection vehicle 2 acquires an operation time of the hydraulic device of the waste collecting portion 26 at each waste collection spot. Note that there may be a case where the hydraulic device of the waste collecting portion 26 is operated multiple times at the same waste collection spot. In this case, it is possible to acquire a total working time of the hydraulic device of the waste collecting portion 26 at a single waste collection spot in conjunction with, for example, a GPS function of the waste collection vehicle 2.

The server 3 communicates with the communication unit 18 of the waste collection vehicle 2 via the network N, and acquires an operation time of the hydraulic device of the waste collecting portion 26 at each waste collection spot. Thereby, the server 3 calculates an accumulated operation time of the hydraulic device of the waste collecting portion 26 of one of the waste collection vehicles 2, and outputs, as an estimation value, the weight of waste from the first information of the graph (intermittent activation) shown in FIG. 1 (step S2).

The timing of communication between the communication unit 33 of the server 3 and the communication unit 18 of the waste collection vehicle 2 via the network N may be either immediately after each operation of the hydraulic device of the waste collecting portion 26 has ended, or may be, for example, after collection of waste at all the waste collection spots that had been scheduled has ended.

Next, it is assumed, for example, that a worker of the waste collection vehicle 2 has selected the second mode in a state in which the waste storing portion 24 of the waste collection vehicle 2 is empty, and inputs the selected operation mode to the input unit 28 of the waste collection vehicle 2 (step S1). In accordance with the input to the input unit 28, the ECU 16 transmits the selected operation mode (second mode) to the information processing server 3 via the communication unit 18. The server 3 specifies the waste collection vehicle 2.

The worker drives the waste collection vehicle 2, stops it at a predetermined waste collection spot at an event site, for example, presses down the switch of the waste collecting portion 26, and operates the hydraulic device.

The ECU 16 of the waste collection vehicle 2 acquires an operation time of the hydraulic device of the waste collecting portion 26 at the waste collection spot of an event site, for example. Note that there may be a case where the hydraulic device of the waste collecting portion 26 is operated multiple times at the same waste collection spot of the event site. In this case, it is possible to acquire a total working time of the hydraulic device of the waste collecting portion 26 at a single waste collection spot in conjunction with, for example, a GPS function of the waste collection vehicle 2. The server 3 communicates with the communication unit 18 of the waste collection vehicle 2 via the network N, and acquires the operation time of the hydraulic device of the waste collecting portion 26 at the waste collection spot.

Thereby, the server 3 calculates an accumulated operation time of the hydraulic device of the waste collecting portion 26 of one of the waste collection vehicles 2, and outputs, as an estimation value, the weight of waste from the second information of the graph (continuous activation) shown in FIG. 1 (step S2).

The timing of communication between the communication unit 33 of the server 3 and the communication unit 18 of the waste collection vehicle 2 via the network N may be either immediately after each operation of the waste collecting portion 26 has ended, or after collection of waste has ended; however, the former is preferable.

In the case where, for example, the server 3 obtains an operation time of the waste collecting portion 26 immediately after each operation of the waste collecting portion 26 has ended, the server 3 estimates a total weight of the current waste collection vehicle 2 including the weight of waste, as well as the current weight of the waste of the waste collection vehicle 2. Note that, in the case where the first mode is selected, the server 3 may estimate a weight change of the waste collection vehicle 2 at every waste collection spot as compared to that at the previous waste collection spot, that is, a change in weight of the waste.

In the case of estimating such a weight, it is not necessary, for example, to move the waste collection vehicle 2. In the case of, for example, continuously activating the waste collecting portion 26 as in the second mode, the server 3 can obtain weight information of the waste collection vehicle 2 in real time, while driving the hydraulic device of the waste collecting portion 26.

Also, in order to acquire weight information of the waste, it is unnecessary to equip the waste collection vehicle 2 with various sensors such as a weight sensor. This allows the server 3 to estimate the weight of the waste at a lower cost.

As described above, the total weight of the waste collection vehicle 2 including the mounting (the waste storing portion 24 and the waste collecting portion 26) on the waste collection vehicle 2 and the waste affects the rolling resistance Rr, the gradient resistance Rg, and the acceleration resistance Ri of the running resistance Rₜₒₜₐₗ. The server 3 is capable of estimating a current total weight of the waste collection vehicle 2 including the waste. Accordingly, the server 3 is capable of more accurately calculating the running resistance Rₜₒₜₐₗ of the waste collection vehicle 2 by using the current total weight of the waste collection vehicle 2 including the waste as a parameter.

The server (processor) 3 acquires information on the weight of the waste based on the first information or the second information in accordance with the specified operation mode. Such weight information of the waste in the first and second modes can be used for, for example, energy management of the waste collection vehicle 2.

If, for example, an operation time of the hydraulic device of the waste collecting portion 26 of the waste collection vehicle 2 stopping at a certain point is relatively long, causing the weight of the waste to relatively increase, the power efficiency is likely to be affected in subsequent operation. For example, the greater the weight of the waste, the greater the power consumption required for the waste collection vehicle 2 to travel up a slope. Thus, in the case of collecting household waste, for example, it is possible to suppress power consumption required for the waste collection vehicle 2 to travel up a slope by adjusting a waste collection route in such a manner that waste is collected first from spots where the operation time of the hydraulic device of the waste collecting portion 26 is relatively short.

Note that the weight of waste can be calculated by measuring the total weight of the waste collection vehicle 2 at a facility such as a waste incineration plant, etc. Upon receiving, from the ECU 16 of the waste collection vehicle 2, a relationship between an accumulated operation time of the waste collecting portion 26 in a series of waste collection procedures and a weight of the waste of the waste collection vehicle 2, the server 3 acquires a relationship between the accumulated operation time of the mounting and waste weight information. The server 3 updates the information (first information and second information) of the graph of FIG. 1 stored in the storage unit 32. The server 3 compares actual weights (calculation values) of waste of a large number of waste collection vehicles 2 with an estimation value of the weight of waste corresponding to the accumulated activation time of the hydraulic device of the waste collecting portion 26, and updates the information of the graph shown in FIG. 1, thereby improving the precision of the graph of FIG. 1.

The data of the graph of FIG. 1 depends on the operation time of the hydraulic device of the waste collecting portion 26, and thus does not need to be acquired for every route on which household waste is collected. This allows the apparatus (server) 3 for estimating weight information of waste according to the present embodiment to estimate a weight of waste at a lower cost. As a matter of course, the server 3 may acquire a graph showing a relationship between the operation time of the mounting and the waste weight information for each route on which household waste is collected, and estimate the weight of the waste based on information on the acquired graph.

The server 3 according to the present embodiment estimates a weight of waste in each of the first and second modes and uses the estimated weight for calculating a running resistance of the waste collection vehicle 2, thereby contributing to creation of a high-precision operation schedule (with an optimized course) for the waste collection vehicle 2, while suppressing power consumption of the waste collection vehicle 2.

A non-transitory storage medium storing a program for estimating weight information of waste according to the present embodiment is configured to cause a computer to: specify one of a plurality of modes as an operation mode of a waste collection vehicle, the plurality of modes including a first mode in which waste is collected at a plurality of locations or spots by activating a mounting on the waste collection vehicle for a shorter period of time than a predetermined period of time at each of the spots, and a second mode in which waste is collected by continuously activating the mounting for the predetermined period of time or longer; acquire an activation time during which the mounting on the waste collection vehicle has been activated in the specified operation mode; and acquire the information on the weight of the waste based on the activation time and the operation mode.

According to the present embodiment, it is possible to provide an apparatus (server) 3 for estimating weight information of waste, a method for estimating weight information of waste, and a non-transitory storage medium storing a program for estimating weight information of waste, whereby a weight of waste can be estimated at a lower cost.

In the present embodiment, it is assumed that the ECU 16 receives an input, via the input unit 28, of information as to whether a first mode or a second mode has been selected, and communicates with the server 3 to allow the server 3 to acquire a weight of waste corresponding to an activation time of the hydraulic device of the waste collecting portion 26 in the selected operation mode. That is, in the present embodiment, an example has been described in which an operation mode selected via the input unit 28 of the waste collection vehicle 2 is set. The server 3 may be configured, for example, to receive information (data) related to continuity of the operation time of the hydraulic device of the waste collecting portion 26 from the waste collection vehicle 2 every time the operation of the hydraulic device is stopped, and determine whether the waste collecting portion 26 is intermittently activated in the first mode or continuously activated in the second mode, namely, set the operation mode. Accordingly, the server 3 may automatically determine the operation mode based on the moving situation of the waste collection vehicle 2 and the activation situation of the waste collecting portion 26. In the case where such determination is performed by the server 3, the input unit 28 may be omitted.

The server 3 is capable of predicting power efficiency that changes according to the weight of waste of each waste collection vehicle 2 with higher precision. This allows the operation service provider of the waste collection vehicle to optimize the course for waste collection and to realize a higher-precision operation schedule and higher-precision energy management, as well as higher-precision charging management, thus reducing the operation cost of the waste collection vehicle 2 and reducing energy consumption in providing operation service of the waste collection vehicle 2.

In the case where an engine vehicle such as a diesel vehicle, a hybrid electric vehicle (HEV), a plug-in hybrid electric vehicle (PHEV), or a fuel cell electric vehicle (FCEV) is used in place of an EV as the above-described waste collection vehicle 2, the power for driving the hydraulic device of the waste collecting portion 26 of the waste collection vehicle 2 is obtained by a system known as a power take-off (PTO), which employs an output of an engine mainly during stopping of the waste collection vehicle 2. In such a case, light oil is used as an energy source for the engine vehicle. The amount of light oil to be used as the energy source can be estimated by the server 3 as the amount of energy consumption. Thus, the power efficiency of an EV or the fuel efficiency of an engine vehicle may be estimated by estimating the weight of waste using the server (apparatus) 3 for estimating the weight of waste according to the present embodiment.

In the present embodiment, an example has been described in which a first mode and a second mode are set as the options. However, a third mode may be set in addition to the first mode in which household waste is collected and the second mode in which waste at an event site, for example, is collected.

Moreover, the server (processor) 3 may be configured, in the first mode, to estimate at least one of a weight of waste collected by a single collection process at a certain collection spot, a total weight (accumulated weight) of waste, or a change in weight of waste, according to the waste types into which waste is sorted.

### Second Embodiment

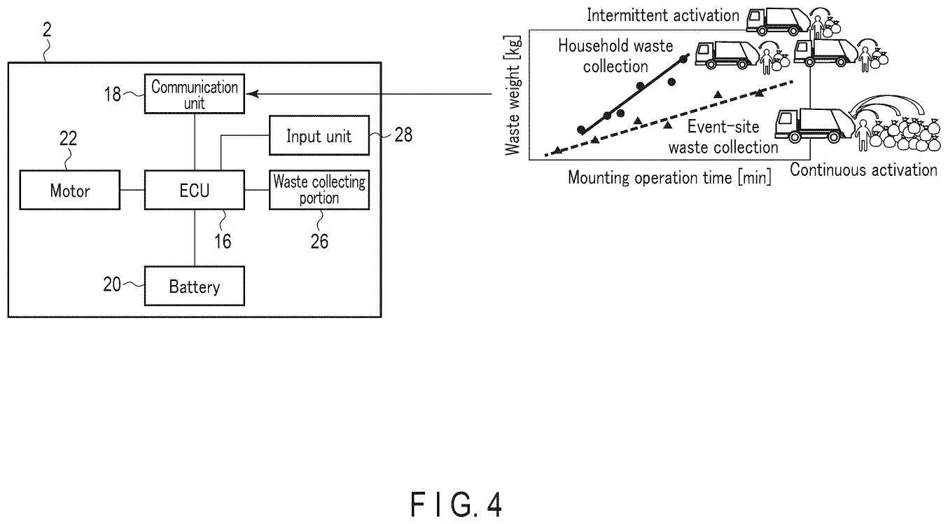

FIG. 4 is a schematic diagram showing a waste collection vehicle 2 including an apparatus (ECU) 16 for estimating weight information of waste according to a second embodiment.

In the first embodiment, an example has been described in which the server 3 is configured to estimate a total weight of each waste collection vehicle 2 as an apparatus for estimating weight information.

The ECU 16 of the waste collection vehicle 2 shown in

FIG. 4 may be used as an apparatus for estimating weight information of waste, and a program that follows the flow shown in FIG. 3 may be executed by the ECU 16. In this case, at the time of calculating a weight of waste, the ECU 16 may be configured to estimate a relationship between the operation time of the waste collecting portion 26 provided as a mounting and a weight of waste as shown in the graph of FIG. 1 through reading from the storage unit of the ECU 16, or through acquisition via the communication unit 18. In this case, the waste collection vehicle 2 includes an apparatus (ECU) 16 and/or a program for estimating weight information.

According to the present embodiment, it is possible to provide an apparatus (ECU) 16 for estimating weight information of waste, a waste collection vehicle 2, a method for estimating weight information of waste, and a non-transitory storage medium storing a program for estimating weight information of waste, whereby a weight of waste can be estimated at a lower cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for estimating weight information of waste, the apparatus comprising a processor configured to:
specify one of a plurality of modes as an operation mode of a waste collection vehicle, the plurality of modes including:
a first mode in which waste is collected at a plurality of spots by activating a mounting on the waste collection vehicle for a shorter period of time than a predetermined period of time at each of the spots; and
a second mode in which waste is collected by continuously activating the mounting for the predetermined period of time or longer;
acquire an activation time during which the mounting on the waste collection vehicle has been activated in the specified operation mode; and
acquire information on a weight of the waste based on the activation time and the operation mode.

2. The apparatus according to claim 1, further comprising a storage medium configured to store:
first information related to a change in weight of the waste relative to the activation time of the mounting in the first mode; and
second information related to a change in weight of the waste relative to the activation time of the mounting in the second mode,
wherein
the processor is configured to acquire the information on the weight of the waste based on the first information or the second information in accordance with the specified operation mode.

3. The apparatus according to claim 1, wherein
the processor is configured to estimate, in the first mode, at least one of a total weight of the waste or the change in weight of the waste in accordance with a type of the waste.

4. The apparatus according to claim 1, wherein the processor is configured to set the operation mode in response to a user input.

5. The apparatus according to claim 1, wherein the processor is configured to acquire information related to continuity of the activation time of the mounting, and set the operation mode based on the information.

6. An apparatus for estimating weight information of waste, the apparatus comprising a processor configured to:
specify one of a plurality of modes as an operation mode of a waste collection vehicle, the plurality of modes including:
a first mode in which waste is collected at a plurality of spots located across a predetermined area by activating a mounting on the waste collection vehicle at each of the spots located across the predetermined area, and
a second mode in which waste is collected at a plurality of spots located across a wider area than the predetermined area by activating the mounting at each of the spots located across the wider area;
acquire an activation time during which the mounting on the waste collection vehicle has been activated in the specified operation mode; and
acquire information on a weight of the waste based on the activation time and the operation mode.

7. A waste collection vehicle comprising the apparatus for estimating weight information according to claim 1.

8. A method for estimating weight information of waste, comprising:
specifying one of a plurality of modes as an operation mode of a waste collection vehicle, the plurality of modes including:
a first mode in which waste is collected at a plurality of spots by activating a mounting on the waste collection vehicle for a shorter period of time than a predetermined period of time at each of the spots, and
a second mode in which waste is collected by continuously activating the mounting for the predetermined period of time or longer;
acquiring an activation time during which the mounting on the waste collection vehicle has been activated in the specified operation mode; and
acquiring information on a weight of the waste based on the activation time and the operation mode.
